(19) United States
(12) Patent Application Publication
(10) Pub. No.: US 2026/0237669 A1
(43) Pub. Date: Aug. 13, 2026

(54) DRY ELECTRODE, METHOD FOR MANUFACTURING SAME, AND SECONDARY BATTERY INCLUDING SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Yongil Cho, Hwaseong (KR); Youngsoo Lee, Hwaseong (KR); Hannah Song, Hwaseong (KR); Minju Kim, Hwaseong (KR); Si Hun Kim, Seoul (KR); Tae Geun Lee, Ansan (KR); Jang Wook Choi, Seoul (KR)

(21) Appl. No.: 19/239,440

(22) Filed: Jun. 16, 2025

(30) Foreign Application Priority Data
Feb. 11, 2025 (KR) 10-2025-0017338

(51) Int. Cl. H01M 4/62; H01M 4/04; H01M 4/36; H01M 10/0525

(52) U.S. Cl. CPC H01M 4/622; H01M 4/0435; H01M 4/366; H01M 4/625; H01M 10/0525

(57) ABSTRACT

Provided is a dry electrode, a method for manufacturing the same, and a secondary battery including the same. The dry electrode includes an electrode active material, a binder, and a polyether-based polymer compound. The polyether-based polymer compound is present in an amount of 0.1 wt. % to 15 wt. % based on 100 wt. % of the total content of the dry electrode. This composition improves process efficiency by enabling dry fabrication and enhances electrode performance by stabilizing the structure.

### CROSS-REFERENCE TO RELATED APPLICATION

This present application claims the benefit of under 35 U.S.C. § 119 (a) Korean Patent Application No. 10-2025-0017338, entitled “DRY ELECTRODE, MANUFACTURING METHOD OF THE SAME AND SECONDARY BATTERY COMPRISING THE SAME,” filed on Feb. 11, 2025, in the Korean Intellectual Property Office, the entire disclosure of which is incorporated herein by reference.

### BACKGROUND

### Technical Field

The present disclosure relates to a dry electrode, a method for manufacturing the same, and a secondary battery including the same.

### Background

To improve the energy density of secondary batteries, research is being conducted on manufacturing electrodes with increased thickness. However, existing electrode manufacturing technologies based on a wet process have limitations in achieving greater thickness. Accordingly, electrode manufacturing technologies based on a dry process, which allows for the formation of thicker electrodes, have attracted attention. Furthermore, since these technologies do not use a solvent, a separate process for drying the solvent is not required, making them more economical and environmentally friendly while also improving process efficiency.

Polytetrafluoroethylene (PTFE), a typical binder used in dry processes, may undergo electrochemical decomposition near 0.5 V (vs. Li/Li+). This is because PTFE is unstable due to the large number of fluorine atoms attached to carbon in its polymer molecular structure. Accordingly, there is a need for a technology that can address this issue.

### SUMMARY

The present disclosure is directed to providing a dry electrode in which the decomposition of a binder during charging and discharging may be significantly suppressed.

In addition, the present disclosure is directed to providing a method for manufacturing a dry electrode solely through a dry process.

Further, the present disclosure is directed to providing a secondary battery with significantly improved initial Coulombic efficiency (ICE).

Some embodiments of the present disclosure provide a dry electrode including an electrode active material, a binder and a polyether-based polymer compound, wherein the polyether-based polymer compound is present in an amount of 0.1 wt. % to 15 wt. % based on 100 wt. % of the total content of the dry electrode.

The polyether-based polymer compound may be present in an amount of 2 wt. % to 5 wt. % based on 100 wt. % of the total content of the dry electrode.

The polyether-based polymer compound may have a melting point of 120° C. or lower. The polyether-based polymer compound may include a polyalkylene glycol.

The polyalkylene glycol may include at least one selected from the group consisting of polyethylene glycol, polypropylene glycol, and a copolymer including polyethylene glycol and polypropylene glycol.

The polyether-based polymer compound may have a weight-average molecular weight of 100 g/mol to 70,000 g/mol.

Alternatively, the polyether-based polymer compound may have a weight-average molecular weight of 400 g/mol to 25,000 g/mol.

At least a portion of the surface of the electrode active material may be coated with the polyether-based polymer compound.

The electrode active material may include a positive electrode active material or a negative electrode active material.

The binder may include one or more resins or polymers of various types such as fluorinated resins, aromatic resins e.g. polystyrenes), polyacrylates, polyimides. More specifically, suitable binders may include e.g. at least one selected from the group consisting of polytetrafluoroethylene (PTFE), polyvinylidene fluoride (PVDF), cellulose, styrene-butadiene rubber (SBR), polyimide (PI), polyacrylic acid (PAA), alkali polyacrylate, polymethyl methacrylate (PMMA), polyacrylonitrile (PAN), and a combination thereof. The dry electrode may further include a conductive material.

Some embodiments of the present disclosure provide a method for manufacturing a dry electrode, the method including preparing a mixture comprising an electrode active material, a binder, and a polyether-based polymer compound, and rolling the mixture to manufacture the dry electrode, wherein the polyether-based polymer compound is present in an amount of 0.1 wt. % to 15 wt. % based on 100 wt. % of the total content of the mixture. The mixture may be free of a solvent.

The polyether-based polymer compound may include a polyalkylene glycol.

The polyalkylene glycol may include at least one selected from the group consisting of polyethylene glycol, polypropylene glycol, and a copolymer including polyethylene glycol and polypropylene glycol.

Still some embodiments of the present disclosure provide a secondary battery including a positive electrode, a negative electrode, and an electrolyte, wherein one or more of the positive electrode or the negative electrode is the dry electrode according to any one of the foregoing embodiments.

The dry electrode according to the present disclosure may significantly suppress the decomposition of the binder during charging and discharging.

According to the method for manufacturing the dry electrode of the present disclosure, the dry electrode capable of significantly suppressing the decomposition of the binder during charging and discharging may be manufactured solely through a dry process. According to the present disclosure, a thicker electrode with improved quality may be manufactured in a time- and cost-efficient manner.

The secondary battery including the dry electrode according to the present disclosure may have a significantly improved initial Coulombic efficiency.

In some embodiments, a dry electrode is provided. The electrode comprises an electrode active material; a binder; and a polyether-based polymer compound in an amount of about 0.1 wt % to 15 wt % based on 100 wt % of a total content of the dry electrode, wherein the polyether-based compound is a copolymer including polyethylene glycol (PEG) and polypropylene glycol (PPG), and wherein the mass ratio of PEG to PPG in the copolymer is from about 1.9:1 to 9:1.

The copolymer of PEG and PPG may be a block copolymer having PEG and PPG as repeating segments, and the weight-average molecular weight of the polyether-based polymer compound may be from about 100 g/mol to 70,000 g/mol.

The dry electrode may further comprise a carbon-based conductive material selected from the group consisting of natural graphite, artificial graphite, carbon black, carbon fiber, carbon nanotubes, graphene, graphene oxide, and activated carbon. The conductive material may be present in an amount of about 0.1 wt % to 10 wt % based on 100 wt % of the total content of the dry electrode.

In some embodiments, a secondary battery is provided. The battery includes a positive electrode; a negative electrode; and an electrolyte. The negative electrode is the aforementioned dry electrode. When the negative electrode is assembled into a half-cell with lithium metal as a counter electrode and charged under a constant-current/constant-voltage protocol at 0.1 C to a cutoff voltage of 10 mV followed by constant-voltage charging at 10 mV until the current decreases to 0.05 C, the half-cell/exhibits an initial Coulombic efficiency of at least 81%.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a graph showing the initial Coulombic efficiency of half-cells incorporating the dry electrodes of Examples 1 to 7 and Comparative Example 1.

FIG. 2 is a voltage-specific capacity curve of half-cells incorporating the dry electrodes of Examples 1 to 7 and Comparative Example 1.

### DETAILED DESCRIPTION

Embodiments described in the present specification can be modified into various other forms, and the technology according to various aspects is not limited to the embodiments described below. The various aspects are provided to make the description of the present disclosure thorough and to fully convey the scope of the present disclosure to those skilled in the art.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, numerical ranges used in this specification include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

In the present specification, when a layer, film, region, plate, or the like is described as being “on” or “above” another part, it encompasses both cases where it is directly on the other part and cases where the other part is interposed therebetween.

In the present specification, a polyether-based polymer compound refers to a polymer compound having a polyether bond (—O—) as a repeating unit.

In the present specification, a polyalkylene glycol refers to a polymer compound prepared by the polymerization of alkylene oxide. The alkylene oxide refers to a compound having an epoxide structure, such as ethylene oxide, propylene oxide, and butylene oxide. Exemplary alkylene oxides include, for example, ethylene oxide, 1,2-propylene oxide, 2,3-propylene oxide, 1,2-butane oxide, 2-methyl-1,2-butaneoxide, 2,3-butane oxide, tetrahydrofuran, epichlorohydrin, hexane oxide, a glycidyl ether such as Bisphenol A diglycidyl ether, or other polymerizable oxirane. In aspects, C₂-C₁₆-alkylene oxides may be preferred. Alkylene oxides also have been characterized as cyclic ethers with the general formula (CH2)n-O(CH2)n, where each n is the same or different positive integer.

The term “electrode active material” herein refers to a material capable of electrochemically absorbing and releasing lithium ions or other charge-carrying ions.

The term “block copolymer” herein refers to a copolymer in which two or more distinct polymer chains or blocks of different compositions (e.g., PEG blocks and PPG blocks) are covalently bonded end to end.

The term “half-cell” herein refers to an electrochemical cell that contains only one electrode under investigation (e.g., a negative electrode) along with a reference or counter electrode (e.g., lithium metal).

The term “initial coulombic efficiency” (ICE) herein refers to the ratio (expressed as a percentage) of the first discharge capacity to the first charge capacity in a charge-discharge test.

As used herein, “dry electrode” refers to an electrode formed or manufactured substantially without using any solvent (organic or aqueous) during the mixing, binding, or coating steps.

As referred to herein, dry electrode technology or similar term can refer to essentially solventless or solventless (no solvent) manufacturing process for example that uses a dry mixture of battery components, like active materials, binders, and conductive additives, to create electrodes, instead of e.g. wet slurry methods that rely on solvents. In aspects, a dry electrode coating process may apply a dry (no or minimal solvent) mixture of active materials and conductive additives to the electrode substrate.

Various embodiments of the present disclosure are directed to a dry electrode capable of significantly suppressing the decomposition of a binder during charging and discharging, a method for manufacturing the same, and a secondary battery including the same.

A dry electrode according to one embodiment of the present disclosure includes an electrode active material, a binder, and a polyether-based polymer compound. The polyether-based polymer compound may be present in an amount of 0.1 wt. % to 15 wt. % based on 100 wt. % of the total content of the dry electrode.

The dry electrode including 0.1 wt. % to 15 wt. % of a polyether-based polymer compound may be capable of significantly suppressing the decomposition of the binder during charging and discharging. Specifically, when the dry electrode does not include a polyether-based polymer compound, the binder may react with lithium ions and decompose during charging and discharging at 1 V (vs. Li/Li+) or below. Such decomposition of the binder may reduce the amount of lithium ions involved in charging and discharging in the secondary battery, thereby adversely affecting the capacity characteristics of the secondary battery. On the other hand, when the dry electrode includes 0.1 wt. % to 15 wt. % of a polyether-based polymer compound, the polyether-based polymer compound may interrupt the electron transport path between the electrode active material and the binder. Accordingly, the electrochemical decomposition reaction of the binder may be kinetically inhibited, and the amount of irreversibly consumed lithium ions may be reduced. A secondary battery incorporating such a dry electrode may have significantly improved initial Coulombic efficiency, resulting in high capacity and high energy density.

At least a portion of the surface or the entire surface of the electrode active material may be coated with the polyether-based polymer compound. As a result, the electron transport path between the electrode active material and the binder may be more effectively interrupted, thereby further suppressing the decomposition of the binder during charging and discharging.

At least a portion of the surface or the entire surface of both the electrode active material and the binder may be coated with the polyether-based polymer compound. As a result, the electron transport path between the electrode active material and the binder may be even more effectively interrupted, thereby markedly suppressing the decomposition of the binder during charging and discharging.

The polyether-based polymer compound may be present in an amount of 0.1 wt. % to 15 wt. %, 0.5 wt. % to 15 wt. %, or 0.5 wt. % to 10 wt. % based on 100 wt. % of the total content of the dry electrode. When the content of the polyether-based polymer compound falls within the above range, the decomposition of the binder during charging and discharging may be significantly suppressed.

Preferably, the polyether-based polymer compound may be present in an amount of 1.8 wt. % to 10 wt. % based on 100 wt. % of the total content of the dry electrode. When the content of the polyether-based polymer compound falls within the above range, the decomposition of the binder during charging and discharging may be more significantly suppressed.

More preferably, the polyether-based polymer compound may be present in an amount of 2 wt. % to 5 wt. % based on 100 wt. % of the total content of the dry electrode. When the content of the polyether-based polymer compound falls within this range, the decomposition of the binder during charging and discharging may be even more significantly suppressed.

The polyether-based polymer compound may have a lower melting point than the binder and may have a melting point of 120° C. or lower. In various exemplary embodiments, the polyether-based polymer compound may have a melting point of 100° C. or lower, 80° C. or lower, or 60° C. or lower, with a lower limit of, for example, 10° C. or higher or 20° C. or higher. For example, the polyether-based polymer compound may have a melting point of 10° C. to 100° C., 20° C. to 80° C., or 20° C. to 60° C. As a result, the electrode active material may be more uniformly coated with the polyether-based polymer compound, thereby more significantly suppressing the decomposition of the binder during charging and discharging. The melting point of the polyether-based polymer compound or the binder may be measured using differential scanning calorimetry (DSC).

The polyether-based polymer compound may include a polyalkylene glycol. In various exemplary embodiments, the polyalkylene glycol may include at least one selected from the group consisting of polyethylene glycol (PEG), polypropylene glycol (PPG), and a copolymer including PEG and PPG.

When the polyether-based polymer compound includes polypropylene glycol, a copolymer including polyethylene glycol and polypropylene glycol, or a combination thereof, the decomposition of the binder may be more significantly suppressed.

The copolymer including polyethylene glycol and polypropylene glycol includes PEG and PPG as repeating units and may be a random copolymer or a block copolymer. Examples of block copolymers may include linear structures such as poly(ethylene glycol-b-propylene glycol), poly(ethylene glycol-b-propylene glycol-b-ethylene glycol), or poly(propylene glycol-b-ethylene glycol-b-propylene glycol). The copolymer including PEG and PPG may have a PEG-to-PPG ratio of 1:9 to 9:1 or 6:4 to 9:1 based on the mass ratio of repeating units. However, the PEG-to-PPG ratio is not particularly limited thereto as long as the resulting copolymer, when used to coat the electrode active material, effectively suppresses binder decomposition.

The polyether-based polymer compound may have a weight-average molecular weight of 100 g/mol to 70,000 g/mol. The weight-average molecular weight may be a polyethylene glycol-equivalent weight-average molecular weight measured using gel permeation chromatography. When the weight-average molecular weight of the polyether-based polymer compound falls within the above range, the decomposition of the binder during charging and discharging may be more significantly suppressed. However, when the weight-average molecular weight of the polyether-based polymer compound is less than 100 g/mol, its viscosity and mechanical strength may be excessively low, thereby failing to suppress the decomposition of the binder. When the weight-average molecular weight of the polyether-based polymer compound exceeds 70,000 g/mol, the viscosity may become excessively high, resulting in non-uniform coating on the electrode active material. Additionally, excessive viscosity may hinder the movement of lithium ions within the electrode, causing an increase in electrode resistance and a decrease in battery capacity.

In a preferred embodiment, the polyether-based polymer compound may have a weight-average molecular weight of 400 g/mol to 25,000 g/mol, 450 g/mol to 21,000 g/mol, or 450 g/mol to 20,000 g/mol. When the weight-average molecular weight of the polyether-based polymer compound falls within the above range, the decomposition of the binder during charging and discharging may be more significantly suppressed. More preferably, the polyether-based polymer compound may include polypropylene glycol with the aforementioned weight-average molecular weight, a copolymer including polyethylene glycol and polypropylene glycol with the aforementioned weight-average molecular weight, or a combination thereof. Still more preferably, the polyether-based polymer compound may be polypropylene glycol having a weight-average molecular weight of 400 g/mol to 5,000 g/mol or 450 g/mol to 3,000 g/mol, a copolymer including polyethylene glycol and polypropylene glycol having a weight-average molecular weight of 5,500 g/mol to 15,000 g/mol, or a combination thereof.

The electrode active material may include a positive electrode active material or a negative electrode active material.

The positive electrode active material is not particularly limited but may include, for example, an oxide active material or a sulfide active material.

The oxide active material may include: a layered rock-salt type active material such as LiCoO₂, LiMnO₂, LiNiO₂, LiVO₂, or Li₁₊ₓNi_{1/3}Co_{1/3}Mn_{1/3}O₂; a spinel-type active material such as LiMn₂O₄ or Li(Ni_{0.5}Mn_{1.5})O₄; an inverse spinel-type active material such as LiNiVO4 or LiCoVO₄; an olivine-type active material such as LiFePO₄, LiMnPO₄, LiCoPO₄, or LiNiPO₄; a silicon-containing active material such as Li₂FeSiO₄ or Li₂MnSiO₄; a layered rock-salt type active material in which a portion of the transition metal is substituted with a different metal, such as LiNi_{0.8}Co_{(0.2-x)}AlₓO₂ (0<x<0.2); a spinel-type active material in which a portion of the transition metal is substituted with a different metal, such as Li₁₊ₓMn_{2-x-y}M_{y}O₄ (where Mis at least one selected from Al, Mg, Co, Fe, Ni, and Zn, and 0<x+y<2); or lithium titanate such as Li₄Ti₅O₁₂, but is not limited thereto.

The sulfide active material may include copper chevrel, iron sulfide, cobalt sulfide, nickel sulfide, and the like.

The negative electrode active material is not particularly limited but may include, for example, a carbon-based active material, a metal-based active material, or a combination thereof. In various exemplary embodiments, the negative electrode active material may include at least one selected from the group consisting of graphite, silicon, silicon oxide, a silicon-carbon composite, and a combination thereof. The silicon-carbon composite may be a composite in which the surface of silicon secondary particles, formed by silicon agglomeration, is coated with a carbon-based material. The carbon-based material may include at least one selected from the group consisting of natural graphite, artificial graphite, amorphous carbon, and a combination thereof.

The electrode active material may be present in an amount of 50 wt. % to 99.8 wt. % based on 100 wt. % of the total content of the dry electrode. When the content of the electrode active material is less than 50 wt. %, a sufficient electron transfer path may not be formed between the electrode active materials, and as a result, the charge and discharge capacity of the secondary battery incorporating the electrode may be reduced.

The binder present in the dry electrode according to one embodiment may improve the cohesion of the constituent materials within the dry electrode. The binder may include at least one selected from the group consisting of polytetrafluoroethylene (PTFE), polyvinylidene fluoride (PVDF), cellulose, styrene-butadiene rubber (SBR), polyimide (PI), polyacrylic acid (PAA), alkali polyacrylate, polymethyl methacrylate (PMMA), polyacrylonitrile (PAN), and a combination thereof. In various exemplary embodiments, the binder may include polytetrafluoroethylene (PTFE).

The binder may be present in an amount of 0.1 wt. % to 49.9 wt. % based on 100 wt. % of the total content of the dry electrode. When the content of the binder exceeds 49.9 wt. %, the binder may hinder the movement of lithium ions within the electrode, causing an increase in electrode resistance and a decrease in battery capacity.

In one embodiment, the dry electrode may include 50 wt. % to 99.8 wt. % of the electrode active material, 0.1 wt. % to 49.9 wt. % of the binder, and 0.1 wt. % to 15 wt. % of the polyether-based polymer compound. The dry electrode may include 50 wt. % to 98 wt. % of the electrode active material, 0.1 wt. % to 48 wt. % of the binder, and 0.1 wt. % to 15 wt. % of the polyether-based polymer compound.

For example, The dry electrode may include 50 wt. % to 98 wt. % of the electrode active material, 0.1 wt. % to 48 wt. % of the binder, and 1.8 wt. % to 10 wt. % of the polyether-based polymer compound. For example, The dry electrode may include 70 wt. % to 98 wt. % of the electrode active material, 0.1 wt. % to 28 wt. % of the binder, and 1.8 wt. % to 10 wt. % of the polyether-based polymer compound.

The dry electrode may further include a conductive material to improve electrical conductivity thereof.

The conductive material may include a carbon-based conductive material. The carbon-based conductive material may include at least one selected from the group consisting of natural graphite, artificial graphite, carbon black, carbon fiber, carbon nanotubes, graphene, graphene oxide, and activated carbon. However, the carbon-based conductive material is not particularly limited thereto as long as it is intended to improve the electrical conductivity of the electrode.

The conductive material may be present in an amount of 0.1 wt. % to 10 wt. % or 0.1 wt. % to 5 wt. % based on 100 wt. % of the total content of the dry electrode. The conductive material may be present in an amount of 0.1 wt. % to 5 wt. % based on 100 wt. % of the total content of the dry electrode. When the content of the conductive material is below the above range, smooth electron transfer pathways within the electrode may not be formed due to an insufficient amount of the conductive material. As a result, the battery capacity may decrease compared to when a sufficient amount of the conductive material is included. On the other hand, when the content of the conductive material exceeds the above range, the excessive conductive material may hinder the movement of lithium ions within the electrode, causing an increase in electrode resistance and a decrease in battery capacity. For example, the dry electrode according to one embodiment may include 50 wt. % to 99.7 wt. % of an electrode active material, 0.1 wt. % to 49.8 wt. % of a binder, 0.1 wt. % to 15 wt. % of a polyether-based polymer compound, and 0.1 wt. % to 10 wt. % of a conductive material.

In one embodiment, the dry electrode may further include a current collector. When the dry electrode further includes a current collector, the dry electrode may include a current collector and an electrode film positioned on at least one surface of the current collector, wherein the electrode film may include an electrode active material, a binder, and a polyether-based polymer compound. The electrode film may further include a conductive material. The electrode active material, the binder, the polyether-based polymer compound, and the conductive material are the same as described above, and thus, a detailed description thereof will be omitted.

A method for manufacturing a dry electrode according to one embodiment of the present disclosure includes: (S1) preparing a mixture comprising an electrode active material, a binder, and a polyether-based polymer compound; and (S2) rolling the mixture to manufacture the dry electrode. The polyether-based polymer compound may be present in an amount of 0.1 wt. % to 15 wt. % based on 100 wt. % of the total content of the mixture.

The dry electrode according to one embodiment of the present disclosure may significantly suppress the decomposition of the binder during charging and discharging. By adding the polyether-based polymer compound in an amount of 0.1 wt. % to 15 wt. % during the manufacturing of the dry electrode, the dry electrode designed according to the present disclosure may be manufactured, offering advantages in process cost and time.

According to the method for manufacturing the dry electrode, in the process of manufacturing the dry electrode by preparing the mixture of the electrode active material, the binder, and the polyether-based polymer compound and rolling the mixture, at least a portion of the surface of the electrode active material may be coated with the polyether-based polymer compound. As a result, the electron transport path between the electrode active material and the binder may be more effectively interrupted, thereby further suppressing the decomposition of the binder during charging and discharging.

S1 is a way of preparing the mixture of the electrode active material, the binder, and the polyether-based polymer compound. A conductive material may further be included to prepare the mixture. The electrode active material, the binder, the polyether-based polymer compound, and the conductive material are the same as described above, and thus, a detailed description thereof will be omitted.

The polyether-based polymer compound may include a polyalkylene glycol. In various exemplary embodiments, the polyalkylene glycol may include at least one selected from the group consisting of polyethylene glycol (PEG), polypropylene glycol (PPG), and a copolymer including PEG and PPG.

S1 may include preparing a composition for manufacturing the dry electrode, including the electrode active material, the binder, and the polyether-based polymer compound, and mixing the composition for manufacturing the dry electrode.

The composition for manufacturing the dry electrode may include 50 wt. % to 99.8 wt. % of the electrode active material, 0.1 wt. % to 49.9 wt. % of the binder, and 0.1 wt. % to 15 wt. % of the polyether-based polymer compound. In various exemplary embodiments, the composition for manufacturing the dry electrode may include 50 wt. % to 98 wt. % of the electrode active material, 0.1 wt. % to 48 wt. % of the binder, and 0.1 wt. % to 15 wt. % of the polyether-based polymer compound.

For example, the composition for manufacturing the dry electrode may include 50 wt. % to 98 wt. % of the electrode active material, 0.1 wt. % to 48 wt. % of the binder, and 1.8 wt. % to 10 wt. % of the polyether-based polymer compound. Alternatively, the composition for manufacturing the dry electrode may include 70 wt. % to 98 wt. % of the electrode active material, 0.1 wt. % to 28 wt. % of the binder, and 0.1 wt. % to 10 wt. % of the polyether-based polymer compound.

The composition for manufacturing the dry electrode may further include the conductive material. The conductive material may be present in an amount of 0.1 wt. % to 10 wt. % or 0.1 wt. % to 5 wt. % based on 100 wt. % of the total content of the composition for manufacturing the dry electrode. For example, the composition for manufacturing the dry electrode according to one embodiment may include 50 wt. % to 99.7 wt. % of the electrode active material, 0.1 wt. % to 49.8 wt. % of the binder, 0.1 wt. % to 15 wt. % of the polyether-based polymer compound, and 0.1 wt. % to 10 wt. % of the conductive material.

In S1, the mixture may not include a solvent. Accordingly, by manufacturing the electrode under dry conditions without using a solvent, it is possible to prevent the formation of defects such as pinholes or cracks in the electrode film. Additionally, there is a process advantage in that the process of drying the solvent can be omitted.

In S1, the mixing is not limited to a specific method and may be performed in various ways as long as the materials to be present in the mixture can be uniformly dispersed. For example, in S1, the materials to be present in the mixture may be introduced into a mixing device such as a blender, mill, mixer, or ultrasonic mixer for mixing.

In S1, the mixing may be performed at a temperature of 10° C. to 120° C. or 25° C. to 100° C.

S2 is a process of rolling the mixture to manufacture the dry electrode. S2 may include rolling the mixture to manufacture the dry electrode film and attaching the dry electrode film to at least one surface of the current collector. The rolling the mixture may be performed using a method known in the art. For example, the dry electrode may be manufactured by applying pressure with rollers, a press machine, or similar equipment.

The secondary battery according to one embodiment of the present disclosure includes a positive electrode, a negative electrode, and an electrolyte, wherein one or more of the positive electrode or the negative electrode may be a dry electrode as described above.

The secondary battery may exhibit significantly improved initial Coulombic efficiency by incorporating the dry electrode that may effectively suppress binder decomposition during charging and discharging. Accordingly, the secondary battery may achieve high capacity and high energy density.

The secondary battery may exhibit an initial Coulombic efficiency of at least 81%. The initial Coulombic efficiency may be at least 84%, at least 85%, at least 86%, or at least 87%.

For example, the secondary battery may be a lithium secondary battery, which may include a lithium-ion battery or a lithium metal battery.

The secondary battery may include the above-mentioned dry electrode as a negative electrode. As an example of a representative secondary battery, a lithium secondary battery may be considered. The positive electrode may be any material capable of reversible lithium-ion intercalation and deintercalation. The positive electrode, for example, may include: lithium oxides with a layered structure such as LiMO₂ (where Mis a transition metal selected from one or more of Co and Ni) or Li_{α}NiₓCo_{y}M_{z}O₂ (where 1≤α≤1.2, α is a real number, 0.2≤x≤0.9, x is a real number, 0.01≤y≤0.5, y is a real number, 0.01≤z≤0.5, z is a real number, x+y+z=1, and M is an element selected from one or more of Mg, Sr, Ti, Zr, V, Nb, Ta, Mo, W, B, Al, Fe, Cr, Mn, and Ce); lithium oxides with a spinel structure such as Li₄Mn₅O₁₂; olivine-structured lithium phosphate-based materials such as LiMPO₄ (where M is Fe, Co, or Mn); or mixtures thereof. However, the positive electrode is not limited thereto.

The electrolyte may include a liquid electrolyte, a solid electrolyte, or a combination thereof, and any electrolyte commonly used in secondary batteries may be applied without restriction. Accordingly, a detailed description thereof is omitted.

Hereinafter, Examples and Experimental Examples are specifically illustrated and described. However, the following Examples and Experimental Examples are provided for illustrative purposes only, and the technology described in this specification is not limited thereto.

### Example 1

A mixture was prepared by mixing 94.5 wt. % of graphite as the negative electrode active material, 2 wt. % of vapor grown carbon fiber (VGCF) as the conductive additive, 3 wt. % of polytetrafluoroethylene (PTFE) as the binder, and 0.5 wt. % of polypropylene glycol (PPG, Mw: 2,000 g/mol) as the polyether-based polymer compound. Subsequently, the mixed negative electrode solid components were processed using a three-roll mill to form a film, resulting in a dry electrode.

### Examples 2 to 17

Except for the content of graphite, VGCF, PTFE, and the polyether-based polymer compound, as well as the type of polyether-based polymer compound, which were adjusted as listed in Table 1 below, dry electrodes were manufactured in the same manner as in Example 1.

### Comparative Example 1

Except for the absence of the polyether-based polymer compound and the adjustment of the graphite content as listed in Table 1 below, a dry electrode was manufactured in the same manner as in Example 1.

### Experimental Example

### Initial Coulombic Efficiency Measurement

Half-cells were assembled using the dry electrodes prepared in Examples 1 to 17 and Comparative Example 1 as negative electrodes, with lithium metal as the counter electrode. The assembled half-cells were charged at a constant current (CC) of 0.1 C until the voltage reached 10 mV, then further charged at a constant voltage (CV) until the charging current reached 0.05 C, completing the first charge cycle. The half-cells were then discharged at a constant current (CC) of 0.1 C until the voltage reached 1.5V, and discharge capacity of the first cycle was measured. The initial Coulombic efficiency (ICE) was determined based on the charge capacity and discharge capacity of the first cycle, and the results are shown in Table 1.

$$Initial Coulombic efficiency = ( discharge capacity of the first cycle / charge capacity of the first cycle ) \times 100$$

TABLE 1

| | Graphite | VGCF | PTFE | Polyether-based polymer compound | | | |
|---|---|---|---|---|---|---|---|
| | Content | Content | Content | Content | | Mw | ICE |
| | (wt. %) | (wt. %) | (wt. %) | (wt. %) | Type | (g/mol) | (%) |
| Example 1 | 94.5 | 2 | 3 | 0.5 | PPG | 2,000 | 75.0 |
| Example 2 | 94 | 2 | 3 | 1 | PPG | 2,000 | 82.2 |
| Example 3 | 93 | 2 | 3 | 2 | PPG | 2,000 | 87.6 |
| Example 4 | 92 | 2 | 3 | 3 | PPG | 2,000 | 85.7 |
| Example 5 | 91 | 2 | 3 | 4 | PPG | 2,000 | 86.5 |
| Example 6 | 90 | 2 | 3 | 5 | PPG | 2,000 | 85.4 |
| Example 7 | 85 | 2 | 3 | 10 | PPG | 2,000 | 84.8 |
| Example 8 | 93 | 2 | 3 | 2 | PPG | 455 | 85.9 |
| Example 9 | 93 | 2 | 3 | 2 | PPG | 2,700 | 87.7 |
| Example 10 | 93 | 2 | 3 | 2 | PEG | 200 | 81.9 |
| Example 11 | 93 | 2 | 3 | 2 | PEG | 1,000 | 81.8 |
| Example 12 | 93 | 2 | 3 | 2 | PEG | 2,000 | 86.7 |
| Example 13 | 93 | 2 | 3 | 2 | PEG | 8,000 | 83.0 |
| Example 14 | 93 | 2 | 3 | 2 | PEG | 20,000 | 85.6 |
| Example 15 | 93 | 2 | 3 | 2 | PEG | 35,000 | 83.8 |
| Example 16 | 93 | 2 | 3 | 2 | A1¹⁾ | 5,800 | 86.3 |
| Example 17 | 93 | 2 | 3 | 2 | A2²⁾ | 14,600 | 87.0 |
| Comparative | 95 | 2 | 3 | 0 | — | — | 70.5 |
| Example 1 | | | | | | | |

¹⁾A1: PEG-PPG-PEG (PEG: 30 wt. %)
²⁾A2: PEG-PPG-PEG (PEG: 82.5 wt. %)

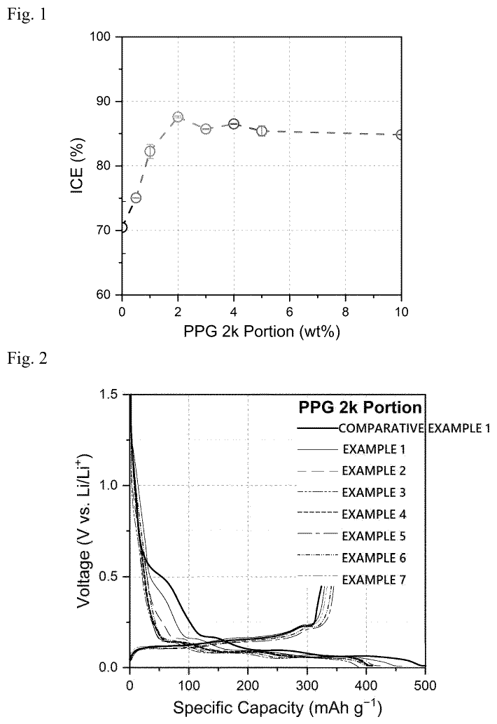

FIG. 1 is a graph illustrating the initial Coulombic efficiency based on the content of the polyether-based polymer compound used. The graph shows the initial Coulombic efficiency of half-cells incorporating the dry electrodes of Examples 1 to 7 and Comparative Example 1.

Referring to Table 1 and FIG. 1, it can be confirmed that in Comparative Example 1, which does not include the polyether-based polymer compound, the initial Coulombic efficiency is lower than that of the Examples 1 to 17. On the other hand, in Examples 1 to 17, which include the polyether-based polymer compound, it was confirmed that the initial Coulombic efficiency is at least 4.5% higher and at most 17.2% higher than that of Comparative Example 1.

FIG. 2 illustrates a voltage-specific capacity curve of half-cells incorporating the dry electrodes of Examples 1 to 7 and Comparative Example 1. As shown in FIG. 2, it can be confirmed that the curve profiles of Examples 1 to 7, which include a polyether-based polymer compound, differ from that of Comparative Example 1 around 0.5V (vs Li/Li+). Additionally, although not illustrated in FIG. 2, the curve profiles of Examples 8 to 17 were also similarly observed around 0.5V (vs Li/Li+). These results suggest that the inclusion of the polyether-based polymer compound alleviates the decomposition of PTFE near 0.5V (vs Li/Li+).

The present disclosure described above is not limited by the aspects described herein and the accompanying drawings. It should be apparent to those skilled in the art that various substitutions, changes, and modifications, which are not exemplified herein but are still within the spirit and scope of the present disclosure, may be made. Therefore, the scope of the present disclosure is defined not by the detailed description but by the claims and their equivalents, and all variations within the scope of the claims and their equivalents are to be construed as present in the present disclosure.

What is claimed is:

1. A dry electrode comprising:
an electrode active material;
a binder; and
a polyether-based polymer compound,
wherein the polyether-based polymer compound is present in an amount of about 0.1 wt. % to 15 wt. % based on 100 wt. % of the total content of the dry electrode.

2. The dry electrode according to claim 1, wherein the polyether-based polymer compound is present in an amount of about 2 wt. % to 5 wt. % based on 100 wt. % of the total content of the dry electrode.

3. The dry electrode according to claim 1, wherein the polyether-based polymer compound has a melting point of about 120° C. or lower.

4. The dry electrode according to claim 1, wherein the polyether-based polymer compound comprises a polyalkylene glycol.

5. The dry electrode according to claim 4, wherein the polyalkylene glycol comprises at least one selected from the group consisting of polyethylene glycol, polypropylene glycol, and a copolymer including polyethylene glycol and polypropylene glycol.

6. The dry electrode according to claim 1, wherein the polyether-based polymer compound has a weight-average molecular weight of about 100 g/mol to 70,000 g/mol.

7. The dry electrode according to claim 6, wherein the polyether-based polymer compound has a weight-average molecular weight of about 400 g/mol to 25,000 g/mol.

8. The dry electrode according to claim 1, wherein at least a portion of a surface of the electrode active material is coated with the polyether-based polymer compound.

9. The dry electrode according to claim 1, wherein the electrode active material comprises a positive electrode active material or a negative electrode active material.

10. The dry electrode according to claim 1, wherein the binder comprises at least one selected from the group consisting of polytetrafluoroethylene (PTFE), polyvinylidene fluoride (PVDF), cellulose, styrene-butadiene rubber (SBR), polyimide (PI), polyacrylic acid (PAA), alkali polyacrylate, polymethyl methacrylate (PMMA), polyacrylonitrile (PAN), and a combination thereof.

11. The dry electrode according to claim 1, further comprising a conductive material.

12. A method for manufacturing a dry electrode, the method comprising:
preparing a mixture comprising an electrode active material, a binder, and a polyether-based polymer compound; and
rolling the mixture to manufacture the dry electrode,
wherein the polyether-based polymer compound is present in an amount of about 0.1 wt. % to 15 wt. % based on 100 wt. % of the total content of the mixture.

13. The method according to claim 12, wherein the mixture is free of a solvent.

14. The method according to claim 12, wherein the polyether-based polymer compound comprises polyalkylene glycol.

15. The method according to claim 14, wherein the polyalkylene glycol comprises at least one selected from the group consisting of polyethylene glycol, polypropylene glycol, and a copolymer including polyethylene glycol and polypropylene glycol.

16. A secondary battery comprising:
a positive electrode;
a negative electrode; and
an electrolyte,
wherein one or more of the positive electrode or the negative electrode is the dry electrode according to claim 1.

17. A dry electrode comprising:
an electrode active material;
a binder; and
a polyether-based polymer compound in an amount of about 0.1 wt % to 15 wt % based on 100 wt % of a total content of the dry electrode,
wherein the polyether-based compound is a copolymer including polyethylene glycol (PEG) and polypropylene glycol (PPG), and wherein the mass ratio of PEG to PPG in the copolymer is from about 1.9:1 to 9:1.

18. The dry electrode according to claim 17, wherein the copolymer of PEG and PPG is a block copolymer having PEG and PPG as repeating segments, and
wherein the weight-average molecular weight of the polyether-based polymer compound is from about 100 g/mol to 70,000 g/mol.

19. The dry electrode according to claim 17, wherein the dry electrode further comprises a carbon-based conductive material selected from the group consisting of natural graphite, artificial graphite, carbon black, carbon fiber, carbon nanotubes, graphene, graphene oxide, and activated carbon, and wherein the conductive material is present in an amount of about 0.1 wt % to 10 wt % based on 100 wt % of the total content of the dry electrode.

20. A secondary battery comprising:
a positive electrode;
a negative electrode; and
an electrolyte,
wherein the negative electrode is the dry electrode according to claim 17, and
wherein, when the negative electrode is assembled into a half-cell with lithium metal as a counter electrode and charged under a constant-current/constant-voltage protocol at 0.1 C to a cutoff voltage of 10 mV followed by constant-voltage charging at 10 mV until the current decreases to 0.05 C, the half-cell exhibits an initial Coulombic efficiency of at least 81%.
